(19) United States
(12) Patent Application Publication
(10) Pub. No.: US 2023/0175316 A1
(43) Pub. Date: Jun. 8, 2023

(54) Cat Door Device

(71) Applicant: Kandace Pearsall, Tacoma, WA (US)

(72) Inventor: Kandace Pearsall, Tacoma, WA (US)

(21) Appl. No.: 18/061,637

(22) Filed: Dec. 5, 2022

Related U.S. Application Data
(60) Provisional application No. 63/285,686, filed on Dec. 3, 2021.

(51) Int. Cl. E06B 7/32

(52) U.S. Cl. CPC E06B 7/32

(57) ABSTRACT

A cat door device that allows cats to pass through a doorway, but also prevents dogs from passing through the same doorway or opening the door. The cat door device has a body with at least one opening that allows a cat to pass through the body, wherein the body attaches to a door via at least one hinge. During use, the body can be rotated about the hinge such that it is perpendicular to the door and is positioned between the door and the door frame. The body can then be secured to the door frame via at least one fastener such that the door cannot be pushed opened by a dog. When not in use, the body can be rotated about the hinge such that it is perpendicular to the rear surface of the door and can be secured to the door in this position via the fastener.

### CROSS-REFERENCE TO RELATED APPLICATION

The present application claims priority to, and the benefit of, U.S. Provisional Application No. 63/285,686, which was filed on Dec. 3, 2021, and is incorporated herein by reference in its entirety.

### FIELD OF THE INVENTION

The present invention relates generally to the field of cat doors. More specifically, the present invention relates to a cat door device primarily comprised of a body with at least one opening that allows a cat to pass through the body, wherein the body attaches to a door via at least one hinge. During use, the body can be rotated about the hinge such that it is perpendicular to the door and is positioned between the door and the door frame. The body can then be secured to the door frame via at least one fastener such that the door cannot be pushed open by a dog. When not in use, the body can be rotated about the hinge such that it is perpendicular to the rear surface of the door and can be secured to the door in this position via the fastener. Accordingly, the present disclosure makes specific reference thereto. Nonetheless, it is to be appreciated that aspects of the present invention are also equally applicable to other like applications, devices, and methods of manufacture.

### BACKGROUND

Individuals who own multiple pets within a single home may have several indoor and outdoor cats and dogs. Keeping dogs out of a cat's area, especially their food and litter box area, can be incredibly difficult. If a door to said area is opened even slightly, a dog can open the door and gain access to the cat's area. This can cause significant distress to a cat, in addition to allowing for the possibility of the dog creating a mess. As a result, many cat and dog owners may make permanent modifications to the door of a cat area in the form of a small hole in a door that a cat can climb through. However, these modifications can ruin the door's aesthetic, in addition to permanently and irreversibly damaging the door.

Therefore, there exists a long-felt need in the art for an improved cat door device. More specifically, there exists a long-felt need in the art for a cat door device that prevents a dog from gaining access to a cat area via a door. Further, there exists a long-felt need in the art for a cat door device that prevents a dog from gaining access to a cat area via a door, wherein the device still allows a cat to access the cat area. In addition, there exists a long-felt need in the art for a cat door device that prevents a dog from gaining access to a cat area via a door, wherein the device still allows a cat to access the cat area without requiring permanent modification to an existing door. Finally, there exists a long-felt need in the art for a cat door device that is visually appealing and that prevents a dog from gaining access to a cat area via a door, wherein the device still allows a cat to access the cat area without requiring permanent modification to an existing door.

The subject matter disclosed and claimed herein, in one embodiment thereof, comprises a cat door device. The device is primarily comprised of a body with at least one opening that allows a cat to pass through the body, wherein the body attaches to a door via at least one hinge. During use, the body can be rotated about the hinge such that it is perpendicular to the door and is positioned between the door and the door frame. The body can then be secured to the door frame via at least one fastener such that the door cannot be pushed open by a dog. When not in use, the body can be rotated about the hinge such that it is perpendicular to the rear surface of the door and can be secured to the door in this position via the fastener. In this manner, the door can open and close freely when the device is not in use. The body may also be comprised of at least one indicia that allows the body to blend into the door and/or door frame to remain visually appealing.

In this manner, the cat door device of the present invention accomplishes all the foregoing objectives and provides a cat door device that prevents a dog from gaining access to a cat area via a door, wherein the device still allows a cat to access the cat area. In addition, the device does not require permanent modification to an existing door and does not inhibit the function of the door. Further, the device remains visually appealing.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cat door device primarily comprised of a body with at least one opening that allows a cat to pass through the body, wherein the body attaches to a door via at least one hinge. The body preferably attaches to an outer edge of a door when in use via at least one hinge. When not in use, the body can be folded perpendicular to the door such that the door can fully close.

The body may also be comprised of at least one indicia that includes, but is not limited to, patterns, logos, emblems, images, symbols, designs, letters, numbers, words, characters, animals, advertisements, brands, colors, etc. In the preferred embodiment, the indicia is in the form of a color and/or pattern that matches the existing door and/or door frame.

The body also has at least one opening that is preferably of a size and shape that allows a cat to pass through the opening, but not a dog. The opening is preferably positioned at or near the portion of the body closest to a floor surface. This allows a cat to easily pass through the opening without having to jump.

The device is also comprised of at least one fastener that connects the body to a door frame when a door is opened, and the body is positioned between the door and the frame. In this manner, the door cannot be pushed open by a dog or other animal. In the preferred embodiment, the fastener is a latch or a hook that can be secured to the door frame. The door frame may also have at least one a reciprocating fastener (such as, but not limited to, a threaded eyelet) that receives the fastener of the door frame.

The device is also comprised of a method of use. First, the body is attached to the outer edge of a door via at least one hinge and at least one fastener. Then, the door can be opened, and the body can be rotated about the hinge such that the body is positioned between the door and the door frame perpendicular to the door. Next, the body can be secured to the door frame via at least one fastener. When not in use, the body can be rotated perpendicular to the door behind the door (i.e., not between the door and door frame) such that the door can be closed.

Accordingly, the cat door device of the present invention is particularly advantageous as it provides a cat door device that prevents a dog from gaining access to a cat area via a door, wherein the device still allows a cat to access the cat area. In addition, the device does not require permanent modification to an existing door and does not inhibit the function of the door. In this manner, the cat door device overcomes the limitations of existing cat doors known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a cat door device of the present invention while attached to a door and a door frame in accordance with the disclosed architecture;

FIG. 2 illustrates a rear view of one potential embodiment of a cat door device of the present invention while attached to a door and a door frame in accordance with the disclosed architecture;

FIG. 3 illustrates a rear view of one potential embodiment of a cat door device of the present invention while attached to a door and a door frame in accordance with the disclosed architecture; and

FIG. 4 illustrates a flowchart of a method of using one potential embodiment of a cat door device of the present invention while attached to a door and a door frame in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cat door device. More specifically, there exists a long-felt need in the art for a cat door device that prevents a dog from gaining access to a cat area via a door. Further, there exists a long-felt need in the art for a cat door device that prevents a dog from gaining access to a cat area via a door, wherein the device still allows a cat to access the cat area. In addition, there exists a long-felt need in the art for a cat door device that prevents a dog from gaining access to a cat area via a door, wherein the device still allows a cat to access the cat area without requiring permanent modification to an existing door. Finally, there exists a long-felt need in the art for a cat door device that is visually appealing and that prevents a dog from gaining access to a cat area via a door, wherein the device still allows a cat to access the cat area without requiring permanent modification to an existing door.

The present invention, in one exemplary embodiment, is comprised of a cat door device primarily comprised of a body with at least one opening that allows a cat to pass through the body. The body attaches to a door via at least one hinge. More specifically, the body preferably attaches to an outer edge of a door when in use via at least one hinge. When not in use, the body can be folded perpendicular to the door such that the door can fully close.

The body may also be comprised of at least one indicia. This indicia includes, but is not limited to, patterns, logos, emblems, images, symbols, designs, letters, numbers, words, characters, animals, advertisements, brands, colors, etc. In the preferred embodiment, the indicia is in the form of a color and/or pattern that matches the existing door and/or door frame.

The body also has at least one opening. The opening is preferably of a size and shape that allows a cat to pass through the opening, but not a dog. The opening is preferably positioned at or near the portion of the body closest to a floor surface. This allows a cat to easily pass through the opening without having to jump.

The device is also comprised of at least one fastener. The fastener connects the body to a door frame when a door is opened, and the body is positioned between the door and the frame. In this manner, the door cannot be pushed open by a dog or other animal. In the preferred embodiment, the fastener is a latch or a hook that can be secured to the door frame. The door frame may also have at least one a reciprocating fastener (such as, but not limited to, a threaded eyelet) that receives the fastener of the door frame.

The device is also comprised of a method of use. First, the body is attached to the outer edge of a door via at least one hinge and at least one fastener. Then, the door can be opened, and the body can be rotated about the hinge such that the body is positioned between the door and the door frame perpendicular to the door. Next, the body can be secured to the door frame via at least one fastener. When not in use, the body can be rotated perpendicular to the door behind the door (i.e., not between the door and door frame) such that the door can be closed.

Accordingly, the cat door device of the present invention is particularly advantageous as it provides a cat door device that prevents a dog from gaining access to a cat area via a door, wherein the device still allows a cat to access the cat area. In addition, the device does not require permanent modification to an existing door and does not inhibit the function of the door. In this manner, the cat door device overcomes the limitations of existing cat doors known in the art.

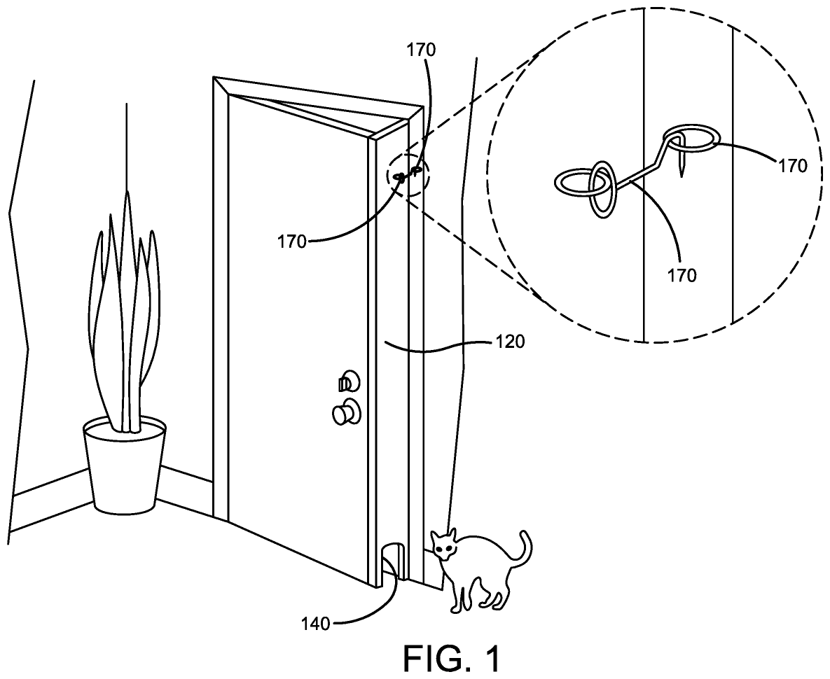

Referring initially to the drawings, FIG. 1 illustrates a front view of one potential embodiment of a cat door device 100 of the present invention while attached to a door 10 and a door frame 30 in accordance with the disclosed architecture. The device 100 is primarily comprised of a body 110 with at least one opening 140, wherein the body 110 attaches to a door 10 via at least one hinge 160. The body 110 is preferably rectangular in shape. However, the body 110 may be any shape provided that it blocks an opening that is created between a door 10 and a door frame 30 when the door 10 is opened.

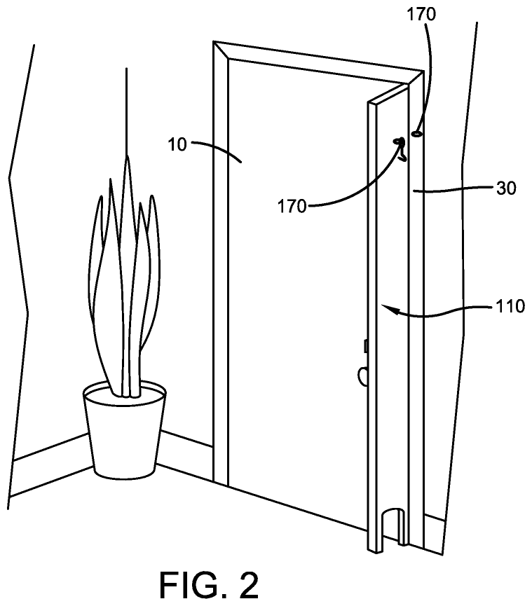

The body 110 preferably attaches to an outer edge 20 of a door 10 when in use. In the preferred embodiment, the rear surface 130 of the body 110 attaches to the outer edge 20 via at least one hinge 160. When not in use, the body 110 can be folded perpendicular to the door 10 such that the door 10 can fully close, as seen in FIG. 2. The hinge 160 is preferably a recessed hinge that is flush with the outer edge 20 to ensure full door 10 closure can occur. The hinge 160 may be attached to the door 10 via at least one secondary fastener 180 such as, but not limited to, a screw, a magnet, an adhesive strip, etc. However, the hinge 160 may be any hinge type known in the art such as, but not limited to, an offset blind hinge, a knuckle hinge, a butt hinge, a rising butt hinge, a gravity pivot hinge, a ball bearing hinge, a barrel hinge, a concealed hinge, a knife hinge, a door hinge, a piano hinge, a strap hinge, a pivot hinge, a gas-piston hinge, an injection molded hinge, a locking hinge, etc.

The body 110 may also be comprised of at least one indicia 150. The indicia 150 includes, but is not limited to, patterns, logos, emblems, images, symbols, designs, letters, numbers, words, characters, animals, advertisements, brands, colors, etc. In the preferred embodiment, the indicia 150 is in the form of a color and/or pattern that matches the existing door 10 and/or door frame 30. For example, the indicia 150 may be a wood-grain pattern to simulate a wood door 10. This allows the device 100 to remain visually appealing.

The body 110 also has at least one opening 140. The opening 140 may be any shape such as, but not limited to, circular, oval, half-circular, etc. The opening 140 is preferably of a size that allows a cat to pass through the opening 140, but not a dog. The exact dimensions of the opening 140 may vary in different embodiments to accommodate various sizes of cats and/or other animals. The opening 140 is preferably positioned at or near the portion of the body 110 closest to a floor surface.

The device 100 is also comprised of at least one fastener 170. The fastener 170 connects the body 110 to a door frame 30 when a door 10 is opened and the body 110 is positioned between the door 10 and the frame 30. In this manner, the door 10 cannot be pushed open by a dog or other animal. In the preferred embodiment, the fastener 170 is a latch or a hook that can be secured to the door frame 30. The door frame 30 may also have at least one a reciprocating fastener 170 (such as, but not limited to, a threaded eyelet) that receives the fastener 170 of the door frame 30. However, the fasteners 170 may be any type and combination known in the art such as, but not limited to, a lock, a latch, a tether, etc.

The fastener 170 may also allow the body 110 to be secured to the rear surface 12 of a door 10. In this embodiment, the rear surface 12 also has at least one fastener 170 that is preferably a reciprocating fastener such as, but not limited to, a threaded eyelet. In the preferred embodiment, the fastener 170 of the body 110 is a latch or a hook that can be secured to fastener 170 of the rear surface 12. However, the fastener 170 may be any type known in the art such as, but not limited to, a lock, a latch, a tether, etc. In this manner, the body 110 can be secured perpendicular to the door 10 when the body 110 is not in use. This allows the door 10 to be opened and closed as normal without the body 110 impeding operation. In one embodiment, the hinge 160 is a locking hinge that allows the body 110 to be locked in said position without the need for a fastener 170 on the rear surface 12.

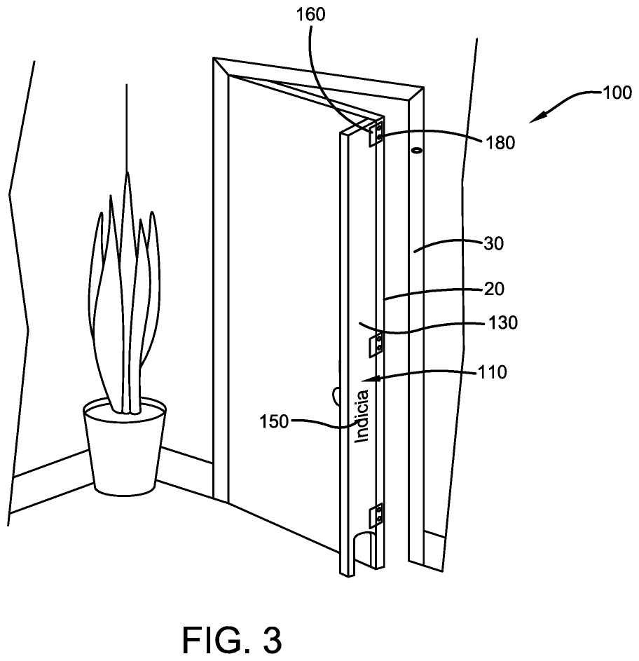

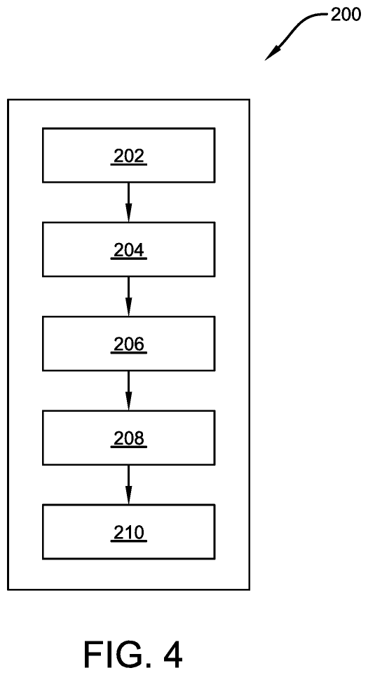

FIG. 4 illustrates a flowchart of a method of using 200 one potential embodiment of a cat door device 100 of the present invention while attached to a door 10 and a door frame 30 in accordance with the disclosed architecture. The device 100 is also comprised of a method of use 200. First, the body 110 is attached to the outer edge 20 of a door 10 via at least one hinge 160 and at least one fastener 180 [Step 202]. Then, the door 10 can be opened [Step 204]. Next, the body 110 can be rotated about the hinge 160 such that the body 110 is positioned between the door 10 and the door frame 30 perpendicular to the door 10, as seen in FIG. 1 [Step 206]. Then, the body 110 can be secured to the door frame 30 via at least one fastener 170 [Step 208]. When not in use, the body 110 can be rotated perpendicular to the door 10 behind the door 10 (i.e., not between the door 10 and door frame 30) such that the door 10 can be closed, as seen in FIG. 2 and FIG. 3 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cat door device” and “device” are interchangeable and refer to the cat door device 100 of the present invention.

Notwithstanding the foregoing, the cat door device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cat door device 100 as shown in the FIGS. are for illustrative purposes only, and that many other sizes and shapes of the cat door device 100 are well within the scope of the present disclosure. Although the dimensions of the cat door device 100 are important design parameters for user convenience, the cat door device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cat door device comprising:
a body;
an opening;
a hinge; and
a fastener.

2. The cat door device of claim 1, wherein the opening is comprised of a circular opening.

3. The cat door device of claim 1, wherein the fastener is comprised of a hook.

4. The cat door device of claim 1, wherein the fastener is comprised of a tether.

5. The cat door device of claim 1, wherein the hinge is comprised of a locking hinge.

6. A cat door device comprising:
a door;
a door frame;
a body;
an opening;
a hinge;
an indicia;
a first fastener;
a second fastener; and
a third fastener.

7. The cat door device of claim 6, wherein the first fastener is positioned on the body.

8. The cat door device of claim 6, wherein the second fastener is positioned on the door frame.

9. The cat door device of claim 8, wherein the second fastener is comprised of a threaded eyelet.

10. The cat door device of claim 6, wherein the third fastener is positioned on the door.

11. The cat door device of claim 10, wherein the third fastener is positioned on a rear surface of the door.

12. The cat door device of claim 10, wherein the third fastener is comprised of a threaded eyelet.

13. The cat door device of claim 7, wherein the first fastener is comprised of a hook.

14. The cat door device of claim 6, wherein the indicia is comprised of a color or a pattern.

15. The cat door device of claim 14, wherein the pattern is comprised of a wood-grain pattern.

16. A method of using a cat door device, the method comprising the steps of:
attaching a body of the cat door device to an outer edge of a door via a hinge of the cat door device;
opening the door;
rotating the body around the hinge such that the body is positioned in the opening between the door and a door frame; and
securing a first fastener of the body to a second fastener of the door frame.

17. The method of claim 16 comprising a further step of removing the first fastener from the second fastener.

18. The method of claim 17 further comprised of a step of rotating the body around the hinge such that the body is perpendicular to a rear surface of the door.

19. The method of claim 18 further comprised of a step of securing the first fastener to a second fastener of the rear surface.

20. The method of claim 19 further comprised of a step of closing the door.
